(19) United States
(12) Patent Application Publication
(10) Pub. No.: US 2005/0015289 A1
(43) Pub. Date: Jan. 20, 2005

(54) Reservation information reference system and method

(75) Inventors: Yoshihisa Tadokoro, Tokyo (JP); Ken Sakakibara, Tokyo (JP); Naoko Hyotani, Kawasaki-shi (JP); Takashi Miyasaki, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/873,940

(22) Filed: Jun. 22, 2004

(30) Foreign Application Priority Data
Jun. 24, 2003 (JP) 2003-179953

(51) Int. Cl. G06F 17/60; H04L 12/50

(52) U.S. Cl. 705/8

(57) ABSTRACT

A reservation information reference apparatus for referencing facility reservation information from a terminal connected to a network is disclosed. The reservation information reference apparatus transmits a request for reservation information for a specified facility and receives the reservation information from a server via a communication device thereof. Subsequently, the reservation information reference apparatus displays, on a screen, a current scene for a terminal associated with the requested reservation information as the facility reservation information received from the communication device.

### BACKGROUND OF THE INVENTION

1. Field of the Invention

The present invention relates to an information sharing system that provides a function for referencing reservation information of facilities.

2. Description of the Related Art

Group information sharing systems have been developed that utilize communication networks, such as intranets and the Internet, to share image information among participants in groups that include a plurality of users. The use of these systems is expected to become increasingly widespread in the future.

In such known systems, a plurality of users can monitor images of their working schedules via a communication network, such as an intranet or the Internet.

For example, such a group information sharing system can include a function to reserve a facility, such as a meeting room. In this known group information sharing system, a user who reserves the facility (hereinafter referred to as “reserver”) sometimes does not need to use the facility after reserving it. In such cases, other users wanting to use the room may not use the room because it has already been reserved. Alternatively, other users may contact the reserver, e.g., via telephone, in order to ask the reserver to confirm whether or not the reserver will actually use the room. Additionally, if a user is not familiar with the facility, the user may be at a loss as to who to call to confirm whether or not the reserver is really going to use the room.

Unfortunately, in such a case, although the user may attempt to ask for transfer of the reservation of the facility, the user often cannot reach the reserver or the manager of the facility, for example if the reserver and/or the manager are on holiday or out of office. Thus, the phone call or the e-mail is a wasted effort, and time has been wasted by the user in his or her efforts to rearrange the use of the facility.

### SUMMARY OF THE INVENTION

The present invention provides a group information sharing system for providing a smooth transfer of facility reservations. The group information sharing system provides smooth communication with a reserver or a manager of a reserved facility by selectively displaying a current scene for a terminal associated with the requested reservation information.

According to an aspect of the present invention, a reservation information reference apparatus for a requester to reference facility reservation information from a requester terminal connected to a network is provided. The reservation information reference apparatus includes a communication device connected to the requester terminal and configured to request reservation information for a specified facility and to receive the reservation information for the specified facility from a server. The reservation information reference apparatus also includes a display control device connected to the requester terminal and configured to receive the reservation information for the specified facility and to display a current scene for a participant terminal associated with the reservation information.

In accordance with an aspect of the present invention, the current scene is an image from a camera connected to the participant terminal. The current scene for the participant terminal may be repeatedly updated.

In accordance with another aspect of the present invention, the display control device is configured to display text information from an input device connected to the participant terminal in addition to displaying the current scene for the participant terminal.

In accordance with yet another aspect of the present invention, the participant terminal is used by a user who has a reservation for the requested facility. Alternatively, the participant terminal may be used by a user who manages the requested facility.

According to another aspect of the present invention, a method for referencing facility reservation information from a requester terminal connected to a network is provided. The method includes transmitting a request for reservation information for a specified facility, receiving the reservation information for the specified facility, and displaying a current scene for a participant terminal associated with the reservation information.

According to another aspect of the present invention, a program for executing a method for referencing facility reservation information from a requester terminal connected to a network is provided. The program includes instructions for transmitting a request for reservation information for a specified facility, receiving the reservation information for the specified facility, and displaying a current scene for a participant terminal associated with the reservation information.

Further features and advantages of the present invention will become apparent from the following description of the preferred embodiments with reference to the attached drawings.

### BRIEF DESCRIPTION OF THE DRAWINGS

FIG. 1 shows a system configuration of a reservation information reference system including terminals and a server in communication over a network, such as the Internet.

FIG. 2 is an example of a display screen of a terminal shown in FIG. 1.

FIG. 3 is a block diagram showing the main components of a terminal shown in FIG. 1.

FIG. 4 is a block diagram showing the main components of the server shown in FIG. 1.

FIG. 5 shows an example of a menu to start a groupware function.

FIG. 6 shows an example of a facility reservation information screen displayed on a terminal shown in FIG. 1.

FIG. 7 shows an example of a detailed facility reservation information screen displayed on a terminal shown in FIG. 1.

FIG. 8 shows an example of a detailed facility information screen displayed on a terminal shown in FIG. 1.

FIG. 9 shows an example of a user management table stored in the server shown in FIG. 1.

FIG. 10 shows an example of a facility management table stored in the server shown in FIG. 1.

FIG. 11 shows an example of a facility reservation management table stored in the server shown in FIG. 1.

FIG. 12 is a flow chart showing exemplary logic of the operation for displaying a current status of a facility reserver in detailed facility reservation information.

FIG. 13 is a flow chart showing exemplary logic of the operation for displaying a current status of a facility manager in detailed facility reservation information.

### DESCRIPTION OF THE PREFERRED EMBODIMENT

An embodiment of the present invention is described below with reference to the accompanying drawings.

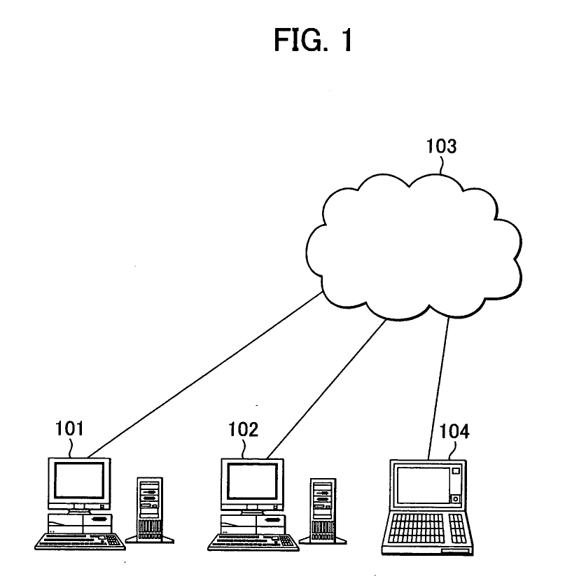

FIG. 1 shows an exemplary system configuration of a group information reference system.

As shown in FIG. 1, terminals 101, 102 communicate with a server 104 via a network 103, such as the Internet. In the exemplary configuration shown in FIG. 1, there are two terminals 101 and 102. However, the group reference system can, and typically will, include more than two terminals. Each of the terminals 101 and 102 incorporates a telecommunications function connected to the Internet 103. The terminals 101 and 102 include personal computers (PCs) that operate under the control of a terminal program of the group information reference system. The server 104 also incorporates a telecommunications function connected to the Internet 103. The server 104 includes a server computer, which operates under the control of a server program of the group information reference system.

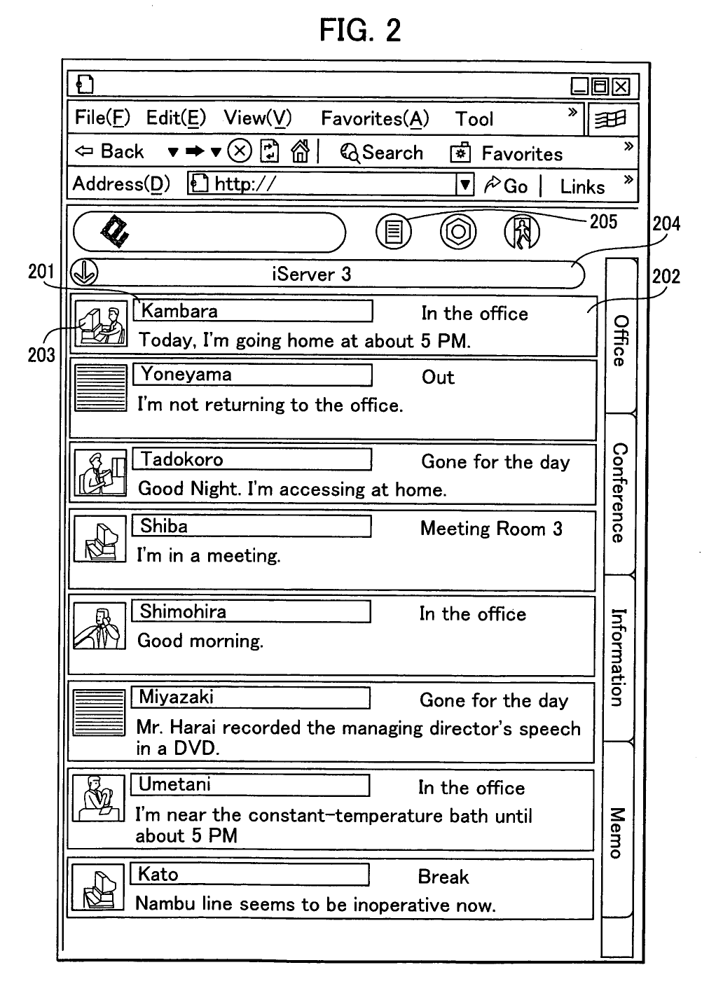

FIG. 2 shows an example of a screen of the group information reference system displayed on the terminals 101 and 102. The display screen of the group information reference system includes a display area for each of the current users in the group. The display area for each of the users includes a user name display area 201, a message display area 202, and an image information display area 203. The message display area 202 includes text information delivered from a terminal used by a user to other users via the server 104. The image information display area 203 is delivered to other users from the terminal via the server 104. The image information display area 203 is continuously distributed via the server 104 so as to notify the status of users accessing the system in near real time. In exemplary embodiments, the image information displayed in the image information display area 203 is an image taken using a video camera that is a part of or in communication with the terminal for the user.

In the exemplary screen of the group information reference system shown in FIG. 2, eight users are registered in one group in the server 104 and access the system. The screen shown in FIG. 2 also includes a group name display area 204 that displays a name of the group to which those users belong. Ordinarily, the screen shown in FIG. 2 is displayed on all of the terminals of users who are group members.

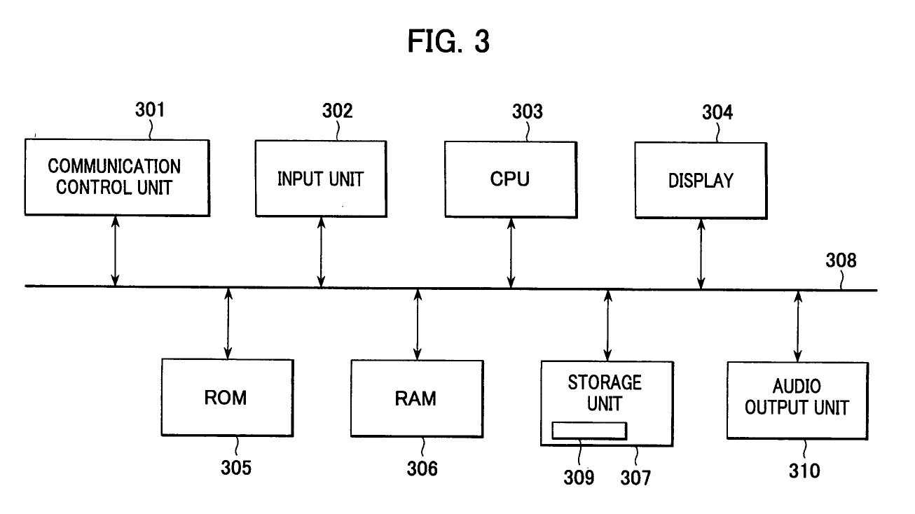

FIG. 3 is a block diagram showing the main components of each of the terminals 101 and 102. As described above, the terminals 101 and 102 include PCs, which operate under the control of the terminal program of the group information reference system. As shown in FIG. 3, each terminal 101 and 102 includes a communication control unit 301, an input unit 302, a central processing unit (CPU) 303, a display 304, a read-only memory (ROM) 305, a random access memory (RAM) 306, and a storage unit 307, all of which are connected to a system bus 308.

The communication control unit 301 controls communication with the Internet 103 and adopts various types of communication interfaces. For direct connection with an access network, the communication control unit 301 includes various types of modems or terminal adaptors. For a connection via an external device, such as an Asymmetric Digital Subscriber Line (ADSL) modem or a cable modem, the communication control unit 301 includes an Ethernet interface.

The input unit 302 typically includes a keyboard, a pointing device, such as a mouse, a microphone, and a video camera. The keyboard is used for a user to input a message for display in the message display area 202 for the user. The video camera is used for capturing images of a user in the office and the background for display in the image information area 203 for the user. As described above, image displayed in the image information area 203 for the user are continuously captured by the video camera for distribution to the users in the group via the server 104.

The CPU 303 controls the overall operation of the personal computer and performs processes in response to commands from the terminal program of the group information reference system. The display 304 includes a cathode ray tube (CRT) or a liquid crystal display (LCD). The screen shown in FIG. 2 is an example of a screen displayed on the display 304.

The ROM 305 stores instructions and data required for the CPU 303. The RAM 306 is used as a working memory required for the operation of the CPU 303. In exemplary embodiments, the storage unit 307 is a hard disk drive. The storage unit 307 stores a terminal program 309 of the group information reference system and data required for the operation of the terminal program 309.

An exemplary audio output unit 310 includes a sound generator circuit, an audio amplifier circuit, and a speaker to output audio signals. As with the other components shown in FIG. 3, the audio output unit 310 is connected to the system bus 308.

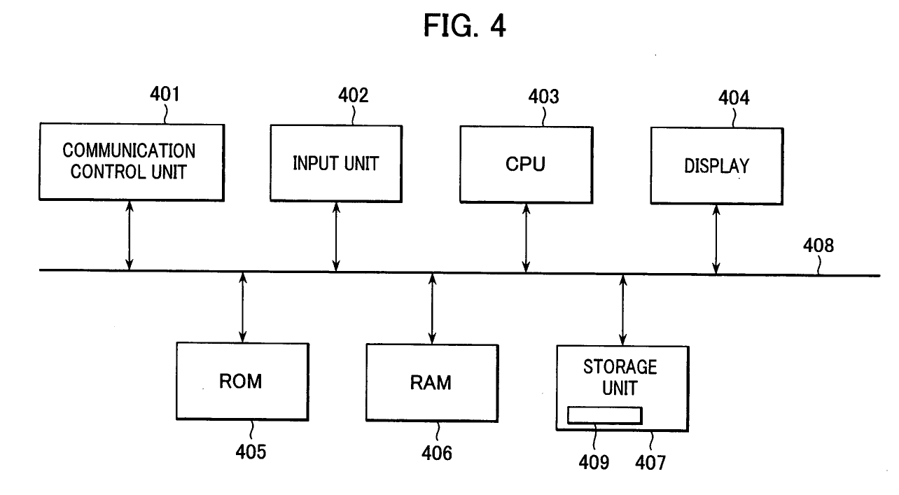

FIG. 4 is a block diagram illustrating the main components of the server 104. As described above, the server 104 includes a server computer, which operates under the control of the server program of the group information reference system. More specifically, the server 104 includes a communication control unit 401, an input unit 402, a CPU 403, a display 404, a ROM 405, a RAM 406, and a storage unit 407, all of which are connected to a system bus 408.

The communication control unit 401 controls communication with the Internet 103. Since the server 104 is generally installed at a network operation center (NOC) of an internet service provider (ISP), which is near the Internet backbone, a high-speed Ethernet interface is used as a communication interface to connect with a router at the NOC.

The input unit 402 includes a keyboard and a pointing device, such as a mouse, to administer the server computer. Instead of using a keyboard and a pointing device, the input for administration may be entered from a computer for remote administration via a network. The CPU 403 controls the overall operation of the server computer and performs processes in response to commands from the server program of the group information reference system. The display 404 includes a CRT or an LCD. The ROM 405 stores instructions and data required for the CPU 403. The RAM 406 is used as a working memory required for the operation of the CPU 403.

In exemplary embodiments, the storage unit 407 is a hard disk drive. The storage unit 407 stores a server program 409 of the group information reference system, data required for the operation of the server program 409, user database information, such as a management table, and message data sent from the terminals 102 and 103.

A facility reservation system, which is part of the above-described group information sharing system, is described next.

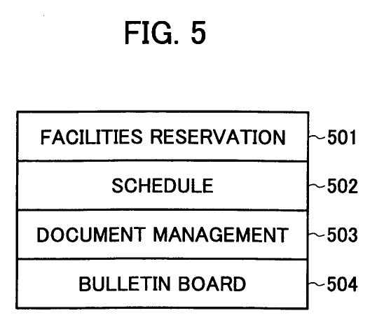

Clicking a groupware start button 205 shown in FIG. 2 displays a groupware select menu such as the one shown in FIG. 5. The user can select a function from the groupware select menu which includes a “facilities reservation” function menu selection item 501, a “scheduler” function menu selection item 502, a “document management” function menu selection 503, and a “bulletin board” function menu selection 504. The “facilities reservation” function is described next. The other functions available from the groupware select menu are not described in further detail herein.

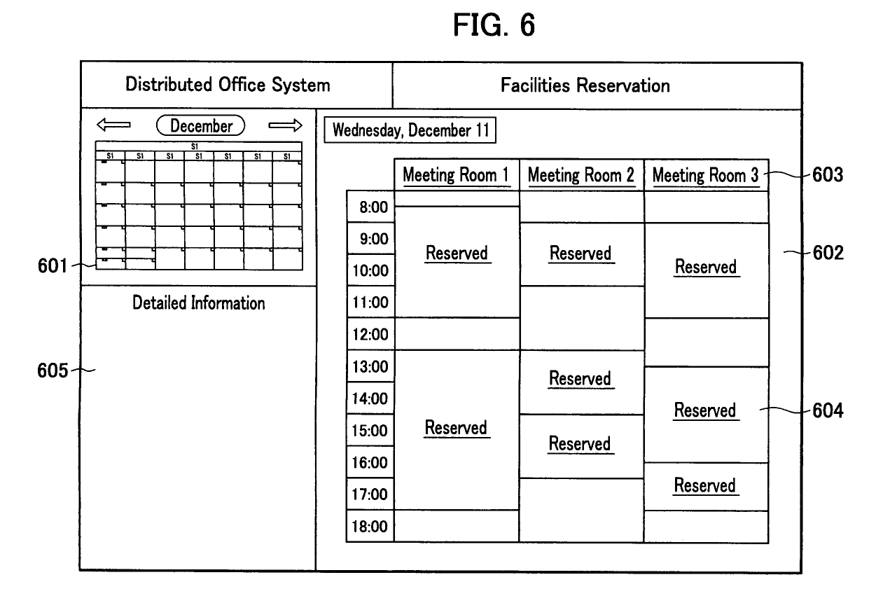

FIG. 6 shows an exemplary screen of the facility reservation function that is displayed when the facility reservation function menu selection 501 in the selection menu shown in FIG. 5 is selected (e.g., the menu item is “clicked”). As shown in FIG. 6, the screen of the “facility reservation” function includes a calendar section 601, a facility reservation information section 602, and a detailed information section 605. The facility reservation information section 602 includes a facility name field 603 and a facility reservation field 604. The facility reservation field 604 indicates that the facility is reserved. The detailed information section 605 displays detailed information about a facility and a reservation. Selecting a date in the calendar section 601 displays the reservation status for that date in the facility reservation information section 602.

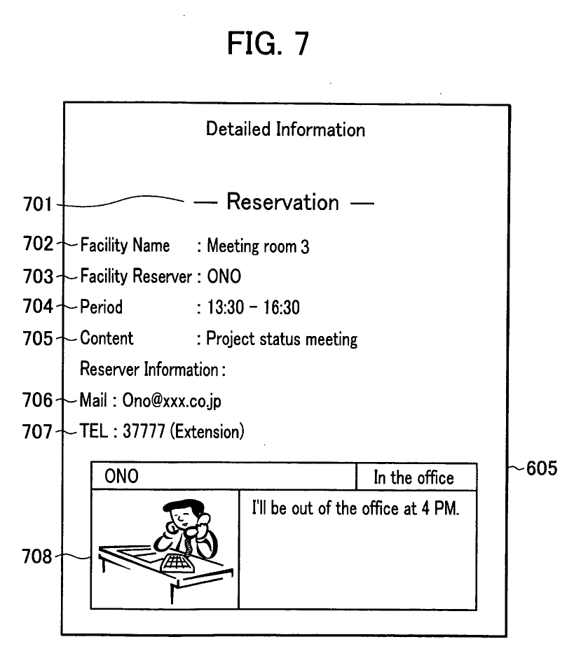

FIG. 7 shows an example of detailed information about a reservation. For example, this information is displayed in the detailed information section 605 by clicking the field 604 displaying the text “Reserved”.

With reference to FIG. 7, the detailed information section 605 includes a type field 701 that displays the type of the detailed information (“Reservation” in the example shown in FIG. 7), a facility name field 702 that displays the reserved facility name, a facility reserver field 703 that displays the name of the reserver, a period field 704 that displays the reserved period, a content field 705 that displays details that the user inputs, such as the purpose of the reservation, a mail field 706 that displays the e-mail address of the reserver, a telephone field 707 that displays the telephone number of the reserver, and a status field 708 that displays the current status of the reserver, which is identical to the corresponding entry shown in FIG. 2.

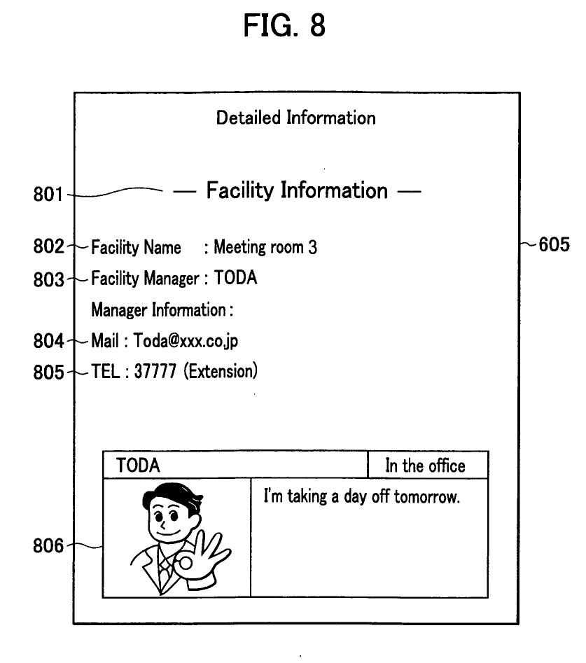

FIG. 8 shows an example of detailed information about a facility. For example, this information is displayed in the detailed information section 605 by clicking the facility name field 603 displaying “Meeting Room 3” in FIG. 6.

With reference to FIG. 8, the detailed information section 605 includes a type field 801 that displays the type of the detailed information (“Facility Information” in the example shown in FIG. 8), a facility name field 802 that displays the reserved facility name, a facility manager field 803 that displays the name of the facility manager, a mail field 804 that displays the e-mail address of the manager, a telephone field 805 that displays the telephone number of the manager, and a status field 806 that displays the current status of the manager, which is identical to the corresponding entry shown in FIG. 2.

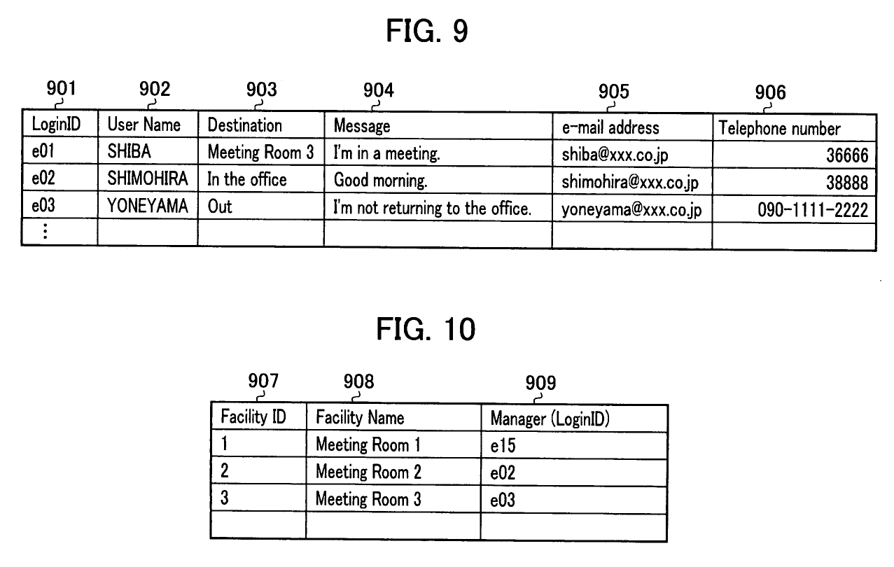

FIG. 9 shows part of a user management table stored in storage unit 407 of the server 104 shown in FIG. 1. With reference to FIG. 9, Login ID 901 is an identification (ID) required for logging into the reservation information reference system. The Login ID 901 is unique and therefore is not duplicated for another user. A user name 902 is defined by a user or a system administrator. A user inputs a user destination 903 and message information 904. The user destination 903 is text information that shows the current whereabouts of the user, such as “in the office”, “out of the office”, or “in a meeting”. The message information 904 is used for a user to input informal information other than the user destination, for example, a greeting. The e-mail address of a user 905 and the telephone number of the user 906 are also stored in the user management table.

FIG. 10 shows a facility management table stored in the server 104 shown in FIG. 1. A unique facility ID 907 is registered without duplicating another facility ID. A facility name 908 and a manager ID 909 for a manager of a facility are also stored in the facility management table. The manager ID 909 is identical to the login ID 901 shown in FIG. 9.

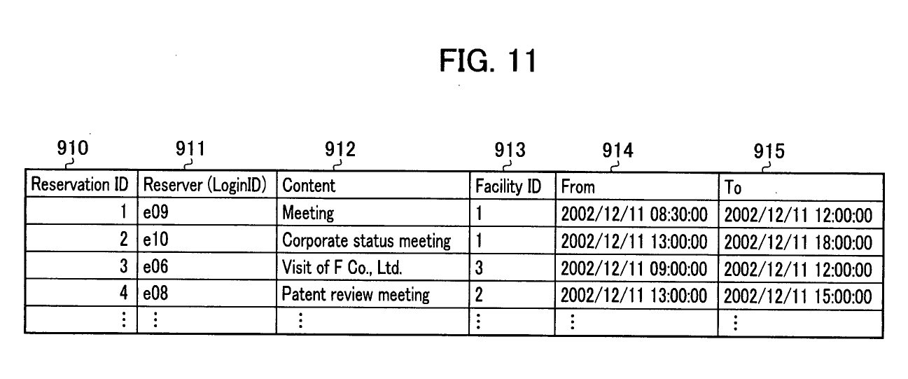

FIG. 11 shows a facility reservation table stored in the storage unit 407 of the server 104 shown in FIG. 1. A reservation ID 910 is a unique reservation ID of a facility that is not duplicated with another reservation ID. A reserver ID 911 is identical to the login ID shown in FIG. 9. A content field 912 contains details about a reservation. A facility ID in a facility ID field 913 is identical to the facility ID 907 shown in FIG. 10. A from time field 914 and a to time field 915 indicate a beginning time and an end time of a facility reservation, respectively.

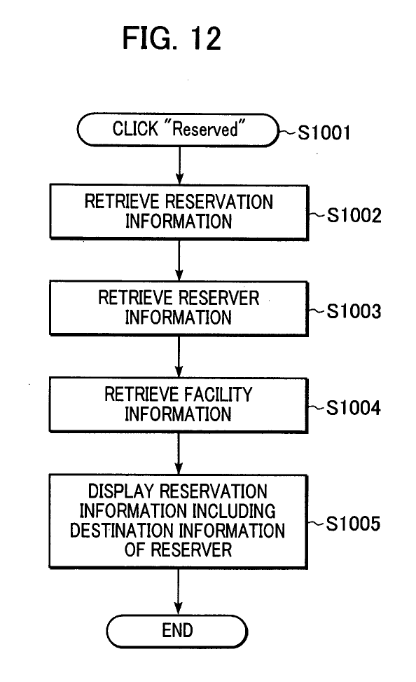

FIG. 12 is a flow chart of the operation of the terminal 101 when displaying detailed reservation information. In step S1001, the system detects a click by a user on the facility reservation field 604 displaying “Reserved” on the display 304 of the terminal 101, as shown in FIG. 6.

In step S1002, the terminal 101 accesses the facility reservation table (shown in FIG. 11) stored in the storage unit 407 of the server 104 via the Internet 103. The terminal 101 retrieves a corresponding facility reservation record from the table.

In step S1003, the terminal 101 extracts a reserver ID (login ID) 911 from the facility reservation record retrieved in step S1002, and then accesses a user management table (shown in FIG. 9) stored in the storage unit 407 of the server 104 via the Internet 103. The terminal 101 retrieves a user record whose login ID 901 matches the login ID 911 from the table.

In step S1004, the terminal 101 extracts a facility ID 913 from the facility reservation record retrieved in step S1002. The terminal 101 then accesses a facility management table shown in FIG. 10 stored in the storage unit 407 of the server 104 via the Internet 103. The terminal 101 retrieves a facility record whose facility ID 907 matches the facility ID 913 from the facility reservation table. Alternatively, step S1004 may be performed prior to step S1003.

In step S1005, the terminal 101 combines the following items as facility reservation information: reservation details (content), a beginning time, and an end time from the facility reservation record retrieved in step S1002; a user name, an e-mail address, and a telephone number from the user record retrieved in step S1003; a facility name from the facility record retrieved in step S1004; and one entry of user information shown in FIG. 2. The items in the user information are selected from the user record and are arranged into a format shown in the status field 708 in FIG. 7. The information is displayed in the detailed information section 605 on the display 304 of the terminal 101 in the format shown in FIG. 7. The server 104 may perform the above-described converting process from the format shown in FIG. 2 to that shown in FIG. 7 to display the information in the detailed information section 605.

Thus, as shown in FIG. 7, the detailed information of a user who makes a reservation for a meeting room (reserver) is displayed showing the current status of the user as a real-time image. Accordingly, a user need not search for the reserver information from the screen shown in FIG. 2 as the user can instantly see the current status of the reserver in the detailed information screen shown in FIG. 7.

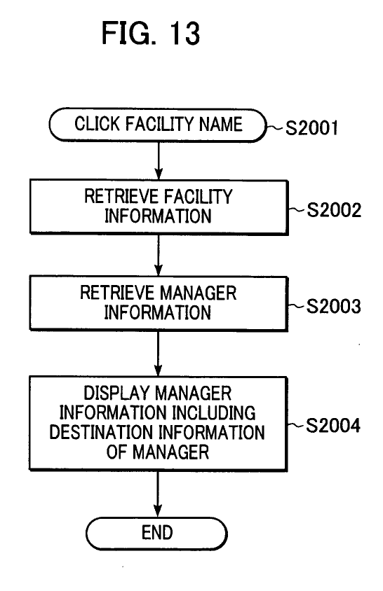

FIG. 13 is a flow chart of the operation of the terminal 101 when displaying detailed manager information. In step S2001, the system detects a click by a user on the facility name field 603 on the display 304 of the terminal 101 shown in FIG. 6.

In step S2002, the terminal 101 accesses the facility table, shown in FIG. 10, stored in the storage unit 407 of the server 104 via the Internet 103, and retrieves a corresponding facility record from the table.

In step S2003, the terminal 101 extracts a manager ID (login ID) 909 from the facility record retrieved in step S2002, and then accesses a user management table shown in FIG. 9 stored in the storage unit 407 of the server 104 via the Internet 103, and retrieves a user record whose login ID 901 matches the login ID 909 from the table.

In step S2004, the terminal 101 combines the following items as facility manager information: a facility name 908 from the facility record retrieved in step S2002, a user name 902, an e-mail address 905, and a phone number 906 from the user record retrieved in step S2003, and one entry of user information shown in FIG. 2 corresponding to the Login ID in the retrieved user record. The information is displayed in the detailed information section 605 shown in FIG. 6 on the display 304 of the terminal 101 in a format shown in FIG. 8.

Thus, as shown in FIG. 8, the detailed information of a manager who manages a meeting room is displayed, showing the current status of the manager as a real-time image. Thus, a user need not search for the manager information from the screen shown in FIG. 2 as the user can instantly see the current status of the manager in the detailed information screen for a facility as shown in FIG. 8.

As described above, in the facility reservation system, facility information includes the current status of a manager who manages the facility. Consequently, a query to a manager for how to use a facility, such as a projector or a company car, or the location of the facility can be simplified. For example, the system prevents a needless phone call to a manager who is out of the office. This system can provide a user with useful information so that the user can choose an effective communication method, such as an e-mail, with a manager who is busy talking on the telephone.

In addition, the facility reservation information includes the current status of a reserver who has reserved a facility. Another user can ask the reserver to transfer the reservation of the facility, such as a meeting room. This prevents a needless phone call to a reserver who is out of the office. This facility reservation system can provide a user with useful information so that the user can choose an effective communication method, such as an e-mail, with a reserver who is busy talking on the telephone.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A reservation information reference apparatus for a requester to reference facility reservation information from a requester terminal connected to a network, the reservation information reference apparatus comprising:
a communication device connected to the requester terminal and configured to request reservation information for a specified facility and to receive the reservation information for the specified facility from a server; and
a display control device connected to the requester terminal and configured to receive the reservation information for the specified facility and to display a current scene for a participant terminal associated with the reservation information.

2. The reservation information reference apparatus according to claim 1, wherein the current scene is an image from a camera connected to the participant terminal.

3. The reservation information reference apparatus according to claim 1, wherein display of the current scene for the participant terminal is repeatedly updated.

4. The reservation information reference apparatus according to claim 1, wherein the display control device is configured to display text information from an input device connected to the participant terminal in addition to displaying the current scene for the participant terminal.

5. The reservation information reference apparatus according to claim 1, wherein the participant terminal is used by a user who has a reservation for the requested facility.

6. The reservation information reference apparatus according to claim 1, wherein the participant terminal is used by a user who manages the requested facility.

7. A method for referencing facility reservation information from a requester terminal connected to a network, the method comprising the steps of:
transmitting a request for reservation information for a specified facility;
receiving the reservation information for the specified facility; and
displaying a current scene for a participant terminal associated with the reservation information.

8. The method according to claim 7, wherein the current scene is an image from a camera connected to the participant terminal.

9. The method according to claim 7, wherein display of the current scene for the participant terminal is repeatedly updated.

10. The method according to claim 7, wherein text information is displayed in addition to the current scene for the participant terminal.

11. The method according to claim 7, wherein the participant terminal is used by a user who has a reservation for the requested facility.

12. The method according to claim 7, wherein the participant terminal is used by a user who manages the requested facility.

13. A program for executing a method for referencing facility reservation information from a requester terminal connected to a network, the program comprising instructions for:
transmitting a request for reservation information for a specified facility;
receiving the reservation information for the specified facility; and
displaying a current scene for a participant terminal associated with the reservation information.

14. The program according to claim 13, wherein the current scene is an image from a camera connected to the participant terminal.

15. The program according to claim 13, wherein display of the current scene for the participant terminal is repeatedly updated.

16. The program according to claim 13, wherein text information is displayed in addition to the current scene for the participant terminal.

17. The program according to claim 13, wherein the participant terminal is used by a user who has a reservation for the requested facility.

18. The program according to claim 13, wherein the participant terminal is used by a user who manages the requested facility.
